(19) United States
(12) Patent Application Publication
(10) Pub. No.: US 2003/0145137 A1
(43) Pub. Date: Jul. 31, 2003

(54) Partially integrating components of processor-based systems

(76) Inventor: Jeffrey L. Huckins, Chandler, AZ (US)

Correspondence Address: Timothy N. Trop, TROP, PRUNER & HU, P.C., 8554 KATY FWY, STE 100, HOUSTON, TX, 77024-1841, US

(21) Appl. No.: 10/058,698

(22) Filed: Jan. 27, 2002

(51) Int. Cl. G06F 3/00

(52) U.S. Cl. 710/8

(57) ABSTRACT

A capability may include a pair of functions, one of which is integrated into a platform and the other of which is only available through an add-in card. A mating manager may determine whether both functions are available and if so, coordinate the operations of those functions. As a result, platforms may be released with the capability to be augmented thereafter by those users who choose to provide the add-in cards needed to implement the capability. Thus, for example, a wireless network capability may be partially integrated into platforms, with additional components needed to actually implement the wireless capability provided through add-in cards.

### BACKGROUND

This invention relates generally to augmenting or updating computer platforms.

In many cases, purchasers of computer platforms, also known as processor-based systems, wish to have the latest technology. In some cases, the latest technology is not quite ready for release at the time a given platform is manufactured. In other cases, manufacturers of processor-based platforms may know of upcoming technology improvements which may or may not yet be available.

Manufacturers who would like to make those improvements available have several considerations. Firstly, manufacturers of platforms may realize that some users may not wish to incur the cost of updates, add-ons and improvements. If every technological improvement or capability were incorporated into every platform, the expense of platforms may become prohibitive for some purchasers.

Secondly, the technology may not yet be ready for release. Therefore, while a platform manufacturer may know of a new upcoming technology, the platform manufacturer may not yet be ready, willing or able to release that technology in the current platform generation. However, there may be some cases where components of the technology may be partially ready but other components needed are not yet available.

For example, currently, processor-based platforms use the peripheral component interconnect (PCI) bus. See PCI Local Bus Specification Revision 2.1 (Jun. 1, 1995). While the peripheral component interconnect bus has been tremendously successful, the speed of processor-based systems today is quickly exceeding the capabilities of peripheral component interconnect buses. Thus, it would be desirable to provide new bus technologies that enable greater performance and speed than existing peripheral component interconnect buses.

However, to incorporate advanced bus technologies into current platforms before those technologies are generally accepted in the industry may be cost ineffective. Some users may not wish to pay for the cost of potential bus technologies, and other users may not wish to incur the cost even if those technologies become a reality. Moreover, in some cases, all the components for implementing a given bus technology may not yet be available and therefore at the time of a given platform's release, only portions of the technology may be available.

Therefore, there is a need for a way to make platforms more upgradable.

### BRIEF DESCRIPTION OF THE DRAWINGS

FIG. 1 is an architectural depiction of one embodiment of the present invention;

FIG. 2 is an embodiment of the device shown in FIG. 1 that operates with the peripheral component interconnect bus;

FIG. 3 is a depiction of a device corresponding to FIG. 1 adapted to a custom bus model in accordance with one embodiment of the present invention; and

FIG. 4 is a flow chart for software in accordance with one embodiment of the present invention.

### DETAILED DESCRIPTION

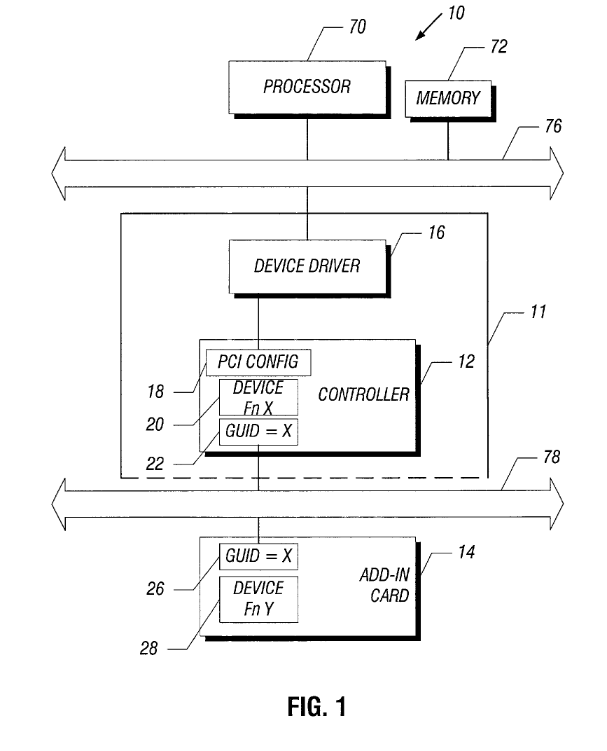

Referring to FIG. 1, a platform 10 may be a processor-based system with a bridge 11, in accordance with one embodiment of the present invention. The bridge 11 may include an integrated controller 12 that is integrated with other hardware and software to implement a function (FnX) which is part of a given capability that also includes another function (FnY).

A bus 78 may couple the bridge 11 and an add-in card 14. The add-in card 14 may provide specific components needed to achieve the function FnY via the device 28. Thus, certain capabilities for providing functions are partially integrated into the controller 11 and platform 10 while other capabilities may be provided only when an add-in card 14 is purchased and coupled to the platform 10.

The platform 10 may include a host bus 76 that couples a processor 70, a memory 72 and the bridge 11 in one embodiment. Other platform architectures may also be used.

In general, higher layer functions may reside on the host platform 10 while the remaining lower layer functional components reside in an add-in card 14 that may be plugged into an external bus 78 as desired by the user or designer of the system 10. Generally, when distributing device functions that are traditionally tightly integrated on add-in cards across an external bus, the bus protocol supports much lower latencies that are obtainable with conventional interfaces.

The partial integration architecture shown in FIG. 1 may be implemented using a single device driver 16 for each partially integrated device such as the controller 12. That driver 16 provides configuration and input/output access to the integrated controller 12 of the platform 10. The partially integrated device driver 16 may not be aware of the underlying platform 10 architecture in some embodiments.

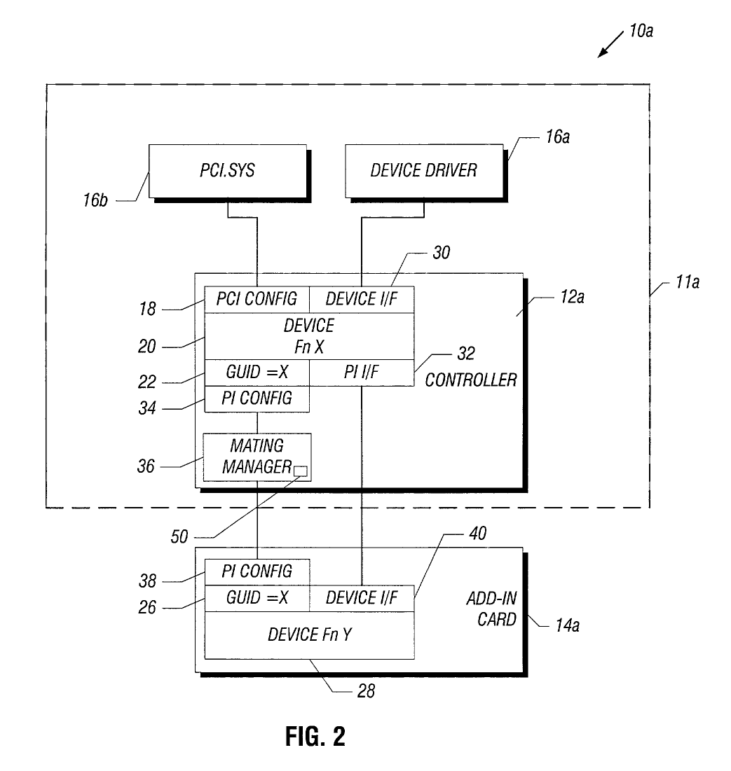

If the add-in card 14 is not found, a mating manager 36, shown in FIG. 2, provides an indication to the platform 10 that the controller 12 is nonfunctional. This discovery and notification process may be accomplished in a variety of fashions depending on specific implementations.

Referring to FIG. 2, a partially integrated component 12a in a bridge 11a interfaces with the peripheral component interface (PCI) bus 78 and includes a mating manager 36 residing within a controller 12a, in accordance with one embodiment of the present invention. The mating manager 36 implements the mating mechanism used to connect the integrated and add-in components of the partially integrated platform 10a. Implementation options for the mating manager 36 are dependent on the bus driver model implemented by the controller 12a.

In the embodiment illustrated in FIG. 2, where the controller 12a is implemented in a peripheral component interface bridge 11a, the peripheral component interface compatibility is maintained. For a peripheral component interface embodiment, the PCI.sys driver 16b is the bus driver for the controller 12a. Obviously, with other bridges utilizing other bus technologies, corresponding drivers may be used.

Advantageously, the mating manager 36 is not implemented in software in the bus driver 16b, but instead is implemented in the controller 12a hardware. In this case, the driver 16b works in conjunction with a conventional device driver 16a. The driver 16b interfaces with a PCI configuration space 18 while the device driver 16a interfaces with an interface 30. The device function FnX may be provided in the device 20. A space 22 provides information about the global unique identifier (GUID) for the integrated controller 12a. Also provided is a partial integration interface 32 that interfaces with the add-in card 14.

The global unique identifier (GUID) space 22 interfaces with a partial integration configuration space 34 also resident in the controller 12a. The mating manager 36 communicates with the partial integration configuration space 34 and a partial integration space 38 resident in the add-in card 14a. The card 14a may also include a global unique identifier (GUID) 26 and a device interface space 40 that interfaces with a corresponding interface on the controller 12a.

The add-in card 14a may include a device 28 to implement the function FnY. The mating manager 36 communicates with both the add-in card 14a and the controller 12a for discovery, enumeration and configuration. The mating manager 36 determines whether or not the add-in card 14a is present and then provides a pointer for add-in device 28 to the integrated device 20 and vice versa, by indicating where an interface, such as control registers, is mapped in memory. The devices 20 and 28 may be hardware, firmware or software modules.

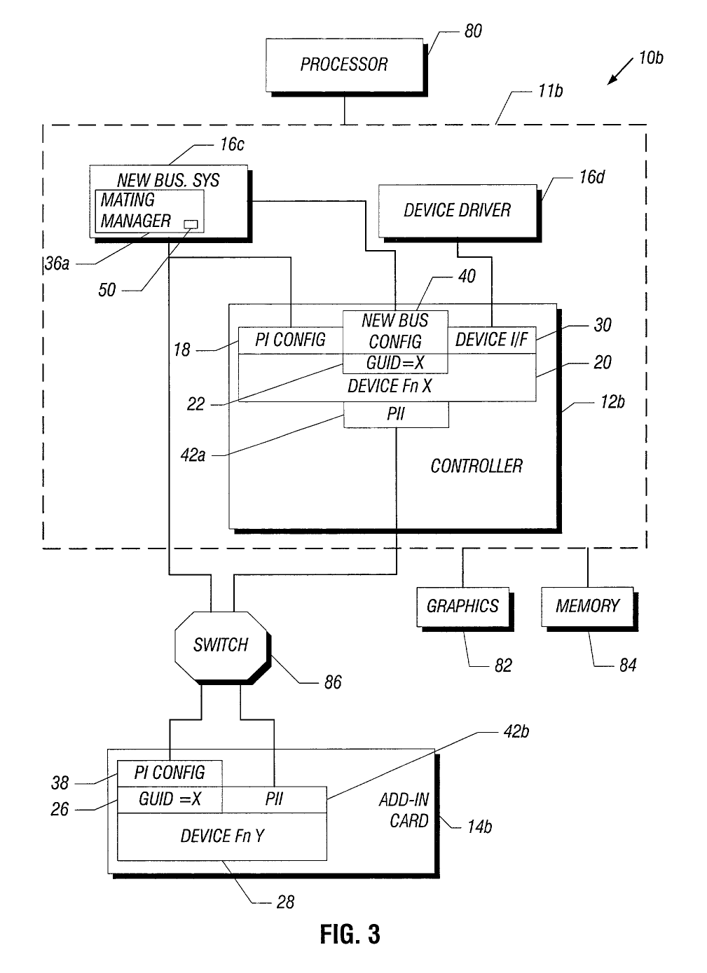

Referring to FIG. 3, in another embodiment of the present invention, a custom bus driver 16c may be provided to communicate directly with the add-in card 14b and the controller 12b. In such an embodiment, the mating manager 36a may be implemented within the custom bus driver 16c. The custom bus driver 16c may provide flexibility; however, it may be necessary to custom define the mating manager 36a.

Thus, the embodiment shown in FIG. 3 differs from the embodiment shown in FIG. 2 in that the mating manager 36a is resident in the bus driver 16c and therefore communicates directly with both the controller 12b and the add-in card 14a. The partial integration interface (PII) 42b interfaces between the add-in card 14b and a corresponding interface 42a on the controller 12b.

Also in FIG. 3, the bridge 11b is coupled to a processor 80, a memory 84 and a graphics device 82 in one embodiment. The add-in card 14b is coupled to the bridge 11b via a switch 86 in one embodiment of the present invention. While the embodiment shown in FIG. 3 is consistent with the so-called Third Generation I/O (3gio) bus technology, other bus technologies may also be implemented.

The custom bus driver 16c also communicates with the configuration space 40 in the controller 12b and a partial integration space 18 in the controller 12b. Meanwhile, the conventional device driver 16d communicates through an interface 30.

In the embodiment shown in FIGS. 1-3, the mating manager 36 enumerates the partially integrated components (functions FnX and FnY for example) resident in the controller 12 and the add-in card 14 by accessing the partial integrated configuration space 18 residing at a well known offset within the controller 12. The partial integration configuration space 18 contains the partial integration, global unique identifier 22 that identifies the unique, partial integration identifier for the partially integrated platform 10. The mating manager 36 then detects the non-integrated components on the attached add-in card 14 via the existence of a partial integration space 38 within the add-in card 14.

The mating manager 36 compares the partial integration interface global unique identifier 26, from the partial integration configuration space 38 of the add-in card 14, with the partial integration, global unique identifiers 22 and the partial integration device 20 in the controller 12. If a match is found, the mating manager 36 writes the mated partial integration device bus information to the partial integration configuration spaces 18 and 38 of the controller 12 and add-in card 14, respectively. The bus information may include all the information necessary for the mated partial integration device 20, 28 components to communicate.

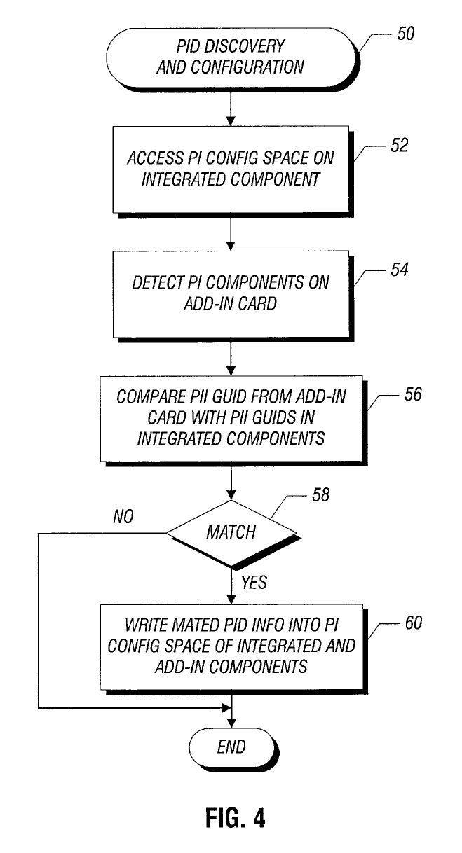

Referring to FIG. 4, the discovery and configuration code 50, in accordance with one embodiment of the present invention, may be stored in association with or merely to be accessible by the mating manager 36. The code 50 initially accesses the partial integration configuration space on the integrated component as indicated in block 52. The mating manager 36 then detects the partial integration components on the add-in card 14 as indicated in block 54. The unique identifiers from the add-in card and the integrated components are compared, as indicated in block 56.

If a match is detected at diamond 58, the mated partially integrated device information is written to the configuration space of the integrated and add-in components as indicated in block 60.

As an example of implementation of the present invention, in the embodiment shown in FIG. 3, the add-in card 14 may implement a network adapter for a wireless network such as a network compatible with the IEEE 802.11 standard. See Institute of Electrical and Electronic Engineers (IEEE) Standard for Information Technology LAN/WAN-Specific Requirements-Part II: Wireless LAN Medium Access Control (MAC) and Physical Layer (PHY) Specifications (1999). In such case, the add-in function (FnY) may be the PHY capability to implement a wireless network adapter and the integrated function (FnX) may be the MAC for the wireless network adapter.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
accessing a configuration space on a platform integrated component;
detecting a component external to said platform, said component intended to operate with said integrated component;
comparing an identifier for said external component with an identifier for said integrated component; and
if said identifiers match, writing information into the configuration spaces of the integrated and external components.

2. The method of claim 1 including accessing said external component through a bus.

3. The method of claim 1 wherein accessing a configuration space includes accessing a configuration space on a controller.

4. The method of claim 3 including detecting a component external to said platform from said controller.

5. The method of claim 1 including accessing a configuration space on said component external to said platform.

6. The method of claim 5 including accessing a global unique identifier from said configuration space on said platform integrated component.

7. The method of claim 6 including accessing a global unique identifier from said configuration space on said component external to said platform.

8. The method of claim 1 including implementing a capability requiring two functions, one of said functions implemented by said platform integrated component and the other of said functions implemented by said component external to said platform.

9. The method of claim 1 wherein writing information includes writing information necessary for the platform integrated component to communicate with said component external to said platform.

10. The method of claim 1 including providing a first function through said platform integrated component and providing a second function through said component external to said platform and utilizing said functions to implement a wireless network capability.

11. An article comprising a medium storing instructions that enable a processor-based system to:
access a configuration space on a platform integrated component;
detect a component external to said platform, said component intended to operate with said integrated component;
compare an identifier for said external component with an identifier for said integrated component; and
if said identifiers match, write information into the configuration spaces of the integrated and external components.

12. The article of claim 11 wherein said medium stores instructions that enable a processor-based system to access said external component through a bus.

13. The article of claim 11 wherein said medium stores instructions that enable a processor-based system to access a configuration space on a controller.

14. The article of claim 13 wherein said medium stores instructions that enable a processor-based system to detect a component external to said platform from said controller.

15. The article of claim 11 wherein said medium stores instructions that enable a processor-based system to access a configuration space on said component external to said platform.

16. The article claim 15 wherein said medium stores instructions that enable a processor-based system to access a global unique identifier from said configuration space on said platform integrated component.

17. The article of claim 16 wherein said medium stores instructions that enable a processor-based system to access a global unique identifier from said configuration space on said component external to said platform.

18. The article of claim 11 wherein said medium stores instructions that enable a processor-based system to implement a capability requiring two functions, one of said functions implemented by said platform integrated component and the other of said functions implemented by said component external to said platform.

19. The article of claim 11 wherein said medium stores instructions that enable a processor-based system to write information necessary for the platform integrated component to communicate with said component external to said platform.

20. The article of claim 11 wherein said medium stores instructions that enable a processor-based system to provide a first function through said platform integrated component, provide a second function through said component external to said platform and utilize said functions to implement a wireless network capability.

21. A system comprising:
a processor;
a bus coupled to said processor;
a device coupled to said bus, said device including a controller having a configuration space; and
a mating manager to coordinate the implementation of a capability incorporated in part in said controller and in part in a component external to said system.

22. The system of claim 21 wherein the mating manager accesses a configuration space on said controller, detects a component external to said system having a configuration space, compares an identifier from said external component with an identifier from said configuration space and, if said identifiers match, writes information into the configuration spaces of said controller and said external component.

23. The system of claim 21 wherein said device implements a network adapter.

24. The system of claim 23 wherein said controller implements the medium access control and said component external to said system implements a physical layer.

25. The system of claim 22 wherein said component external to said system is coupled to said system through said bus.

26. The system of claim 22 wherein said configuration space in said controller includes a global unique identifier and said configuration space on said external component includes a global unique identifier.

27. The system of claim 26 wherein said mating manager compares said global unique identifiers.
